(19) United States
(12) Patent Application Publication
(10) Pub. No.: US 2015/0102631 A1
(43) Pub. Date: Apr. 16, 2015

(54) Transportable Body

(71) Applicant: Paradise Motor Homes Pty Ltd., Biggera Water (AU)

(72) Inventor: Benjamin John Maclean, Biggera Water (AU)

(21) Appl. No.: 14/483,654

(22) Filed: Sep. 11, 2014

(30) Foreign Application Priority Data
Sep. 11, 2013 (AU) 2013903482

(51) Int. Cl. B60P 3/36; B62D 65/00; B62D 29/04

(52) U.S. Cl. CPC B60P 3/36; B62D 29/043; B62D 65/00
USPC 296/168; 296/156; 29/897.2; 29/428

(57) ABSTRACT

A mobile or transportable body that can be moved or transported by motive power, the body having a floor, front and rear ends, opposing side walls and a roof; wherein the floor and each side wall are each formed from at least one panel; the floor has opposing side edges, each side edge having an edge profile defining a plurality of laterally extending projections; each side wall has an upper edge and a lower edge and each side wall lower edge has a plurality of spaced projection receiving sections located towards the lower edge, the floor side edge projections are received within the projection receiving sections of the side walls so as to engage the side walls with the floor.

### FIELD

The present disclosure relates to a body that can transported on or by a motive vehicle. The present disclosure is further directed towards a kit of panels for constructing the body and a method of constructing the body.

The present disclosure is also directed towards an internal furniture fixture for a body that can transported on or by motive power, a body containing the fixture and a method of installing the fixture.

### BACKGROUND

The present disclosure will be described with particular reference to a body that can be transported on or by motive power and that has a living and/or work space such as a caravan or motorhome. However, it will be appreciated that no limitation is intended thereby and the present disclosure is relevant to any suitable body that can be transported on or by motive power.

Bodies that can be transported by motive power include those that may be referred to as passive vehicles, self powered vehicles or those that can be mounted and demounted from a wheeled platform such as a truck or trailer bed.

Passive vehicles are typically mounted on a chassis with a drawbar that is used to attach the chassis to a towing vehicle. The type of body that is built upon the chassis depends upon the end use of the vehicle. Examples of chassis mounted bodies that can be towed include but are not limited to caravans, food supply trailers, cold room trailers, mobile homes, mobile accommodation barracks, site offices, site kitchens, horse floats, food vending vans and the like.

Caravans are one of the most common towed vehicle on the roads. Caravans and other towed vehicles can only legally be towed by vehicles having a specified towing capacity. It is generally not possible to tow caravans with small to medium 2WD passenger vehicles. Large 6 or 8 cylinder passenger cars and preferably 4WD vehicles are generally required to tow caravans. It will be appreciated that in some cases, a person wishing to buy a caravan must also have to purchase a suitable towing vehicle. This can be prohibitively expensive or otherwise undesirable.

Towing large caravans requires a degree of skill as well as adding significantly to fuel consumption. It is therefore desirable for caravans to have a minimum weight so that they may be towed by less experienced drivers, experience better breaking, may be towed by smaller vehicles and may reduce fuel consumption. Further, decreasing the weight of the body can make available a greater amount of the payload for equipment and possessions.

However, caravans having such minimal weight are small in size with few amenities whilst customers are demanding more comfortable caravan accommodation with more amenities, which generally equates to larger and heavier vehicles. Caravan manufacturers, salespersons and users understand that there is a compromise between size and comfort and weight. There is therefore a wide spread and long felt need in the caravan industry to reduce the weight of caravans without significantly sacrificing size and comfort.

The desirability of reducing weight for passive vehicle bodies is not limited to caravans and is generally considered desirable for a wide range of passive vehicles including, trailer mounted mobile offices, mobile barracks such as those used for mining camps, mobile kitchens, mobile libraries, mobile research facilities, mobile cold rooms, mobile doctor surgeries, mobile field hospitals, trailer homes and the like.

Self-powered vehicles have their own engine and motive power and do not need to be towed. They typically comprise a commercial base vehicle such as a cab chassis truck upon which a vehicle body is built or otherwise mounted. The vehicle body is suitably built according to the end use of the vehicle. For example, a motor home defines an interior space made up of a front seat space with a driver's seat and a passenger seat and a rear living region behind and which communicates with the front seat space. The rear living space of the motor home is fitted out with the usual living amenities that enable it to be lived in.

Other types of self-powered vehicles include food transport trucks and vans, prisoner transport vehicles, refrigerated trucks and vans, ice cream vans, animal transport trucks and utility vehicles such as fire service vehicles and ambulances.

The engines of cab chassis vehicles are designed to be able to easily carry the maximum load carrying capacity defined by the manufacturers' specifications. This maxi, ku, weight is known as the Gross Vehicle Mass (GVM). The weight of the body that is built on the chassis must be deducted from the specified pay load. It is therefore desirable to keep the weight of the vehicle body as low as possible.

For example in many countries a truck license is required to drive a vehicle over a certain GVM. In Australia, a light rigid truck license is required in order to drive vehicles with a GVM over 4.5 tonne. It will be appreciated that in the motorhome industry in particular, many motorhome drivers do not have a truck license and must obtain one before they are able to drive a motorhome. This can be inconvenient and some drivers may not be able to comply with stricter truck license requirements.

A very popular size of motorhome has a length of between about 24 to about 28 ft (about 7.3 m to about 8.5 m) 26 ft or about 8 m. Motorhomes of this length that are conventionally constructed have a GVM of about 5 to 5.5 tonne or more.

It has been considered a long felt but unobtainable desire in the motorhome industry to be able to manufacture a 24 to 28 ft motorhome that has a GVM of less than 4.5 tonne that does not compromise body strength, safety, quality of fittings, d comfort and maximum loading. Maximum loading includes the full fresh water tank capacity (generally about 125 L), grey water tank capacity (about 100 L), black water tank capacity (about 38 L), Hot water service tank capacity (about 23 L), gas bottles, generator petrol tank, and fuel tank (about 75 L) plus passengers, luggage and personal effects

Still further types of transportable bodies are those that can be removeably mounted on a wheeled base that may be a truck or trailer bed. Transportable buildings such as those used for remote workers camps or disaster relief and the like may be mounted on steel frames known in the industry as skids. The buildings are transported to the desired site and slid off the truck or trailer bed.

Other types of removeably mounted bodies are demountable camping bodies that can be mounted on the trailer of a utility vehicle. The bodies may be removed when not required for camping so that the utility vehicle can be used for other purposes.

Other transportable bodies that may be deployed to remote locations may be transported by helicopter. Weight is a clear advantage in such applications.

Further important considerations in addition to weight for transportable bodies include durability, strength and resistance to ingress of moisture, dust and other contaminants.

Caravans and other passive vehicles have conventionally been constructed by providing a steel chassis, fixing a floor to the chassis and then fixing furniture cabinets to the floor. Timber or aluminium wall frames are screwed or otherwise fixed to the rear walls of the cabinets. Aluminium cladding is placed on the outside of the frame to form the outer side of the wall and a cladding such as vinyl is placed on the inner side of the wall to form the interior walls. Insulation is placed between the cladding skins. The furniture cabinets provide some limited structural integrity to the caravan.

There are many disadvantages with this conventional type of construction. Cladding joints and places where screws or rivets pass through the cladding allow moisture to enter the walls. Moisture can cause a timber frame to rot and an aluminium frame to corrode.

The rivets, screws and glue are the only places where the walls are held together and which holds the furniture and cabinets to the walls. These points are subject to constant, vibrational, side to side and torsional forces when travelling a road and can loosen. Further, the screws and rivets are subjected to considerable sheer forces in a collision which in many cases causes the walls and roof to become separated. The result is at best that the contents of the caravan are strewn over the road or at worst become hazardous projectiles.

Such disadvantages are not limited to caravans. Vehicle bodies, including self-power vehicles such as motorhomes that are joined together using screw and/or rivets all suffer from the same disadvantages to varying degrees.

An alternative method of body construction suitable for passive and self-powered vehicles such as motorhomes that addresses these disadvantages and provides considerable advantages in terms of structural strength over conventional construction techniques is monocoque construction. In this case, the body is formed from a single piece of fibreglass that is self supporting.

The monocoque construction has a number of advantages with regard to durability and strength. There are no joints, screws, rivets or other fasteners that can work loose when travelling on rough roads or other surfaces. The lack of joints also prevents ingress of moisture, dust and other contaminants and also provides for distribution of shock forces that may be experienced during a collision or accident. There are also no joints that can shear when subject to impact forces.

However, there are a number of industry recognised drawbacks with monocoque construction. Monocoque construction is labour intensive and expensive. Moulds must be custom made for each body configuration. The fibre glass materials are layered onto the interior of the moulds and resinated by hand. Generally two or more moulds are joined to form a single piece shell and the fibreglass is then allowed to cure before being removed from the shell.

Monocoque shells typically have rounded corners as dictated by the method of construction. This can make it more difficult, and expensive to fit out the shell. The lack of structural frame can also make fit out more difficult.

An alternative to monocoque construction that addresses some of the problems of conventional motorhome caravan and other types of transportable body construction as discussed above is to construct the body from panels having foam insulation sandwiched between fibreglass skins. Such panels are known in the art as sandwich panels. The panels are light weight, strong and provide good insulation. The panels are provided in pre formed in lengths that can be accurately cut to size and shape thereby doing away with conventional, labour intensive fibreglass moulding techniques.

Sandwich panels may be conveniently and accurately cut using saws, routers or drills. Windows and doorways can also be accurately cut into the panels.

Methods of constructing vehicle bodies from sandwich panels use mechanical fasters, adhesives or a combination of both to join the panels together. Such construction methods may suffer from the same disadvantages as discussed above in relation to conventional body building. Screws, rivets, adhesives or other fasteners are subject to vibratory forces during use and can become loose. Loose joints are also subject the forces experienced by screws and/or rivets during normal use and during an accident that may subsequently lead to structural failure. Corner joints where walls are joined to the floor are butt joints that are glued together and inherently have low strength. Further it is also difficult to make butt joints square.

Further, conventional methods of joinery can allow ingress of moisture and dirt and dust. This is exacerbated as joints loosen during use and in particular on rough and uneven roads. Periodical maintenance and servicing is necessary.

It is therefore desirable to provide an alternative method of construction of a body that can be transported on or by a motive vehicle.

### SUMMARY

According to a broad aspect of the disclosure, there is provided a body that can be transported on or by a motive vehicle, the body having a floor, a front, a rear end, opposing side walls and a roof

wherein the floor and each side wall are each formed from at least one panel;
the floor has opposing side edges, each side edge having an edge profile defining a plurality of laterally extending projections;
each side wall has an upper edge and a lower edge and each side wall lower edge has a plurality of spaced projection receiving sections that are complimentary to and receive the floor side edge projections so as to engage the side walls with the floor.

The body may be mounted or built upon a wheeled base. The wheeled base may be a vehicle of the cab chassis type that is self powered. The body mounted on the wheeled base may include a motorhome, delivery van, animal transport vehicle, mobile shop, ambulance or the like.

Vehicles of the cab chassis type suitably include a front cabin that includes a driver's seat. The front cabin may be open to the interior of the body to allow internal access between the cabin area and the body. Alternatively, there may be a rear cabin wall that closes of access between the front cabin and the body. In this case, the body may further include a front wall at the front end that sits behind the rear wall of the cabin.

The wheeled base may also be a chassis of a passive vehicle that may be towed The body may include a front wall that may be contoured or otherwise shaped so as to provide an aerodynamic shape in the direction of travel.

The transportable body may also be removeably mounted onto a truck or trailer bed and transported between sites where it may be deployed on site. The floor may be supported on a steel frame known as a skid.

The body of the present disclosure may be moved or transported by motive power. Motive power is generally automotive power such as a car or truck motor. However, other types of power such as train engine power, helicopter or other air transport are not excluded.

The wall and floor panels may be formed from any material or materials that are suitable for the intended purpose of the body and which can be cut or otherwise formed with the desired floor edge profile or projection receiving sections in the side walls.

In many applications such as caravans, motorhomes, refrigeration vehicles, food trucks, class rooms or any application that may house humans, animals, or refrigerated vans it is desired that the body is insulated. Suitable insulated panels are of the sandwich type in which an insulating foam is housed within opposed skins or webs. The skins may be of any suitable material such as fibreglass, aluminium, wood or the like.

Suitable insulating foam includes polystyrene, polyurethane and polyethylene terephthalate (PET). Of these PET is preferred as it is fire resistant and when it does burn does not release toxic gasses.

Alternative panel materials include solid timber or composites such as plywood. In one aspect, the floor may be made from a timber material and the walls from a sandwich panel material.

Suitably, each wall and floor are formed from a single panel. This would generally be the case for applications such as caravans, motorhomes, food vans and the like. However, for some applications, where it is desired to have longer side walls, the walls and/or floor may be comprised of more than one panel. Examples of such applications include class rooms and mobile accommodation trailers. In these cases, the adjoining edges of panels in the same plan, i.e. adjacent floor panel or adjacent side wall panels may have complimentary interlocking profiles.

The body also includes a roof. Suitably the roof is also formed from at least one panel. The roof may have recesses that may receive vertically extending locating projections or tabs on the upper edge of the side walls.

The floor panels have a series of projections spaced along the opposed side edges that are received by the projection receiving sections that are located towards the lower edges of the opposing side walls. The floor panel side profile may be cut using known automated cutting techniques.

The projection receiving sections may be in any suitable configuration or size relative to the projections so that the wall and floor may be joined together.

In one aspect of the disclosure, the projection receiving sections are apertures that extend fully through the side walls. In this case, the projections in the floor are suitably dimensioned such that their length substantially corresponds to the width of the side walls. In this way, the ends of the projections are flush with the outside of the side walls and the interior surface of the side walls abuts the recessed edges of the floor between the projections. The bottom edge of the side walls may therefore extend below the level of the floor.

In this arrangement, the ends of the projections may be visible from the outside of the body. If desired, a cover may be placed along the lower edges of the side walls so as to hide the projections. The cover may also provide an additional structural strength to lower part of the body and/or assist in protecting the lower part of the body from abuse from stone chips, scratches and minor collisions. The cover plate may be formed from a material that can protect the wall panel from such abuse such as aluminium plate known in the art as checker plate.

The projection receiving sections may be also form part of a lower edge profile of the side walls. In this case the profile suitably has a neck portion adjacent the projection receiving section for engaging the side walls relative the floor against vertical forces. Depending upon the manner in which the projection receiving portions are cut or otherwise formed, it may be more efficient or otherwise desirable to form an edge profile rather than discrete apertures.

In a further aspect, the projection receiving sections of the side walls may be in the form of grooves, slots or recesses that do not extend fully through the side walls. In this case, the projections are suitably dimensioned such that their length corresponds to the depth of the recess so as to provide a snug fit within the recess. Further, the ends of the projections are not visible from the outside surface of the side walls. A protective cover as discussed above may also be provided to protect the lower part of the wall against damage.

The projections and projection receiving sections are suitably configured so as to provide a snug fit. The side walls are engaged with the floor by moving the walls laterally so that the projections are engaged by the side walls. When so engaged, it will be appreciated that the side walls are restricted from movement in the direction of the longitudinal axis of the body and in particular the forward direction. Such movement is restricted without the application of any external or additional fixing means such as screws or rivets. It will be appreciated that in the event of a collision, the walls are securely held to the floor by the engagement between the floor projections and the projection receiving apertures of the walls against movement in all directions except for laterally outwards away from the floor In practice, in a collision or roll over, caravan walls are seldom subjected to an outward force.

The body suitably also has a rear end wall. Depending upon the use of the body, the end wall may be fixed to the floor in the same or similar manner to that in which the side walls are engaged with the floor. Suitably in this case, the rear edge of the floor also has a profile having a series of laterally extending spaced projections and the rear wall has a lower edge with spaced apertures towards the edge thereof and the apertures or recesses receive the projections so as to join the rear wall to the rear end of the floor. Alternatively for other applications, the rear wall may be pivotally connected to the floor so as to provide a rear ramp to the body or pivotally connected. to the side walls so as to provide an entrance door or doors.

For motorhome construction, the or each side wall (or rear wall) may also include a slide out. Slide outs are understood to mena a portion of a vehicle that can be displaced outwardly when the vehicle is in a camping mode and is not being driven around whereby to create a larger interior space within the vehicle. The slide out may be mounted on a side wall or a front rear wall of the vehicle and the vehicle may have more than one slide out. According to a further aspect of the disclosure, there is provided a kit for assembling a body that can transported by or on motive power, the body having a floor, a front end, a rear end opposing side walls and a roof; wherein the kit comprises at least one floor panel, at least one side wall panel and at least one other side wall panel; wherein the or each floor panel has opposing side edges, each side edge having a profile with a plurality of laterally extending spaced projections;

each side wall panel has an upper edge and a lower edge and a series of spaced projection receiving sections located towards the lower edge, wherein the spaced projections receiving sections are configured to receive the projections such that the walls are engageable with the floor.

The present inventor has surprisingly and unexpectedly discovered that a motorhome body constructed according to the present disclosure enables a significant weight reduction when compared to conventionally constructed motorhomes without compromising on strength and in fact improved structural strength is observed.

Suitably a motorhome so constructed with a length of between about 324 ft and about 28 ft (about 7.3 m to about 8.5 m) will have a GVM of 4.5 tonne or less.

According to a further aspect of the disclosure, there is provided a method of assembly of a transportable body that can be transported by motive power, the body having a floor, opposing side walls and a roof, the method comprising providing at least one floor panel, at least one side wall panel and at least one other side wall panel; wherein the or each floor panel has opposing side edges, each side edge having a profile with a series of spaced projections;

each side wall panel has an upper edge and a lower edge and a series of spaced projection receiving sections located towards the lower edge, wherein the projections on the floor edges are complimentary to the projection receiving sections;
mounting said wall panels to said side edges of the floor panel(s) by inserting the projections into the projection receiving sections.

Vehicle bodies as broadly disclosed herein are generally fitted with cabinets, appliances, furniture or other fittings, depending upon the end use of the vehicle. It is important that these fittings are firmly secured to the vehicle body to resist coming loose as a result of normal travelling on roads, heavy braking or collision.

As explained in the background section, in conventional caravan construction, the cabinets are fixed to the floor and frame. With sandwich panels, there is no frame to fix the cabinets to. Cabinets are mounted to the walls by conventional joinery techniques. This requires skilled labour and accurate measurements in the confined space. Conventional joinery techniques are subject to the same stresses caused by vibration when travelling on roads, and in the event of collision or accident.

In many cases, cabinets and cupboards hold heavy items. Examples include kitchen cupboards in caravans, mobile kitchens and motorhomes that may carry or hold saucepans, microwaves and other heavy cooking items. The fixtures are subject to constant forces when the body is moving. Forward forces are experienced when braking, rear force when accelerating and sideways forces when cornering, and forces experienced on undulating, rough and/or cambered roads. These forces can weaken or loosen the attachments of fixtures to the body.

In the event of a sudden brake or accident, the effective weight of an object can increase 10 to 20 times or more as a result of the G forces that are experienced. This can result in cabinets and fixtures becoming disengaged with a subsequent damage of the fixture and contents. Still further, disengaged cabinets, fixtures and/or other cabinet contents can become extremely dangerous projectiles in the event of an accident.

Still further, appliances such as televisions, microwaves and refrigerators are fixed to the cabinets. The added weight of these appliances means that the effective weight in the event of an incident may be many hundreds of kilos.

It is generally accepted by safety authorities that fittings in a vehicle such as a motorhome must be capable of withstanding a force of 20 times their weight without being detached. The force is measured by a test known as a static pull test in which the fitting is attached to a cable or chain and subjected to an applied force. The pull test is designed to simulate the forces experienced in a crash and does not require destruction of the vehicle. Pull tests are standard in the vehicle industry for testing seat belts and seat anchor points.

In practice, it has been observed that it is not practically possible to construct a transportable body with fittings that meet the 20 times their weight criteria. The present inventor has observed that for many motorhomes currently on the roads the fittings fail when subjected to a force of much less than 20 times their weight. The net result of this is that appliances such as microwaves, televisions and the like may become deadly projectiles in the event of a collision or other incident.

The present inventor has also addressed this problem by providing an arrangement in which a fixture may be mounted or fitted to an interior wall of a body of sandwich panel construction such that the fixture is more resistant to coming loose and/or shearing away from the wall in an accident.

According to a further aspect of the disclosure there is provided a body of sandwich panel construction, the body comprising a floor and opposed side walls and at least one fixture adjacent to one interior side wall; wherein the fixture has at least one wall member having a rear edge and at least one projection extending from the rear edge, and the internal wall has a recess complimentary to the projection such that the projection is received and secured within the recess in the interior side wall.

The body of this aspect of the disclosure may be any suitable body of sandwich panel construction. Suitably, the body is one that is constructed according to the first aspect of the disclosure, although this is not essential.

However, it has also been surprisingly discovered that by combining the presently disclosed methods of installing and constructing fixtures with the method of forming the body as described above, the fixtures assist in further strengthening the body.

The recess in the interior wall can suitably be accurately cut using conventional techniques such as a lathe, laser cutting, water cutting and the like, prior to construction of the body. It will be appreciated that it is not possible to use such techniques to cut recesses into the walls of a single shell monocoque body.

The fixture may be any suitable fixture having a wall member that is suitably fitted to a body of a mobile vehicle. Such fixtures include but are not limited to kitchen cabinets, cabinets to which kitchen appliances such as ovens, stove tops, microwaves and refrigerators are mounted, pantries, cupboards, bed bases, bed side tables, book cases, shelving, wardrobes, bathroom cabinets, cabinets to which laundry appliances are mounted such as dryers and washing machines, and the like.

The term wall member refers to any vertical structural member of the fixture and includes an outer wall, or inner partition walls. Suitably the wall member is an outer wall.

The wall member has a rear edge with a projection that is received within a corresponding recess in the adjacent interior wall. The advantages of this arrangement include that the wall member is positively engaged with the wall itself. In order for the fixture to break free from the wall and move forwards during an accident when travelling, the projection would need to shear from the main wall member body.

The projection may be of any suitable size or configuration. There may be more than one projection received by one or more than one recess.

Suitably, there is a single projection that extends along the rear edge of the wall member with a length that is between about 20% to about 80%, suitably between about 30% to about 70%, suitably between about 40% to about 60% of the length of the wall member

Another advantage of this aspect is that the recess in the internal wall, provides an accurate means of aligning the fixtures with respect to the internal wall during installation. It will be appreciated that in vehicle bodies, such as motorhomes and caravans, space is at a premium and it is important that all fixtures are installed and fitted in correct alignment with respect to each other. Accurately measuring and aligning of fixtures along an internal wall takes time, requires skilled personnel and adds to construction costs.

Suitably the wall member of the fixture has a bottom edge that is also configured to be engaged by the floor of the body in which case the bottom edge of the wall member has a downwardly extending projection that is received by a corresponding recess in the floor. This arrangement provides still further support in the event of forces generated during an abrupt stop or collision. It will be appreciated that fixtures to which heavy items such as an oven or refrigerator are mounted can considerably increase their effective weight when subject to G forces generated during a sudden brake or upon impact.

A wall mounted fixture such as an overhead cupboard having a top edge that abuts a ceiling or roof may further include an upwardly extending projection that is received by a corresponding recess in the roof.

The fixture may have one or more internal partition walls which may or may not include projections as per the outer walls.

The fixtures may suitably be able to with stand a force of twenty times their weight without becoming detached from the walls. More suitably, the fixtures will not become detached when articles of heavy weight such as microwaves, refrigerators, microwaves, washing machines are fixed thereto or heavy items are stored therein.

According to a further broad aspect of the disclosure, there is provided a kit for use in the construction of a mobile or transportable body having a floor and opposing side walls, the kit including at least one body side wall that in use has an inner and an outer wall surface, at least one fixture wall member having a rear edge and a front edge and a projection extending from the rear edge, wherein the inner wall surface has a recess complimentary with the projection such that the projection is receivable within the recess so as to engage the fixture wall member with the inner wall surface.

According to a further broad aspect of the disclosure, there is provided a method of installing a fixture in body having an inner wall surface, the method including providing a fixture with at least one wall member having a rear edge and a front edge and a projection extending from the rear edge, providing the inner wall with a recess complimentary with the projection and placing the projection of the wall member into the recess in the inner wall surface so as to engage the fixture wall member with the inner wall surface.

According to yet a further aspect there is disclosed a mobile or transportable body that can be moved or transported by motive power, the body having a floor, front and rear ends, opposing side walls and a roof;

wherein the floor and each side wall are each formed from at least one panel;
the floor has opposing side edges, each side edge having an edge profile defining a plurality of laterally extending projections;
each side wall has an upper edge and a lower edge and each side wall lower edge has a plurality of spaced projection receiving sections located towards the lower edge, the floor side edge projections are received within the projection receiving sections of the side walls so as to engage the side walls wall with the floor and which further includes a fixture installed adjacent an inner surface of the or each side wall, wherein the fixture has at least one wall member having a rear edge and a forward edge, and at least one projection extending from the rear edge, the inner surface of the adjacent side wall has a recess complimentary to the projection and the projection is received and secured within the recess.

### BRIEF DESCRIPTION OF THE DRAWINGS

FIG. 1 is view of a kit of parts for the assembly of a one embodiment vehicle body of the present invention;

FIG. 2 is a schematic perspective open in line for assembly view of the vehicle body of FIG. 1

FIG. 3 is a view of a further kit of parts for the assembly of a further embodiment of vehicle body of the present invention;

FIG. 4 is an schematic open in line for assembly view of a further preferred vehicle body of the present invention;

FIG. 5 is a schematic perspective view of a section of a preferred body showing the method of mounting a fixture to an internal wall according to an alternative embodiment of the invention;

FIG. 6 is a top plan view of the fixture shown in FIG. 5,

FIG. 7 is a front view of the fixture shown in FIG. 5; and

FIG. 8 shows an exploded perspective view of the fixture shown in FIG. 5.

### DETAILED DESCRIPTION OF THE FIGURES

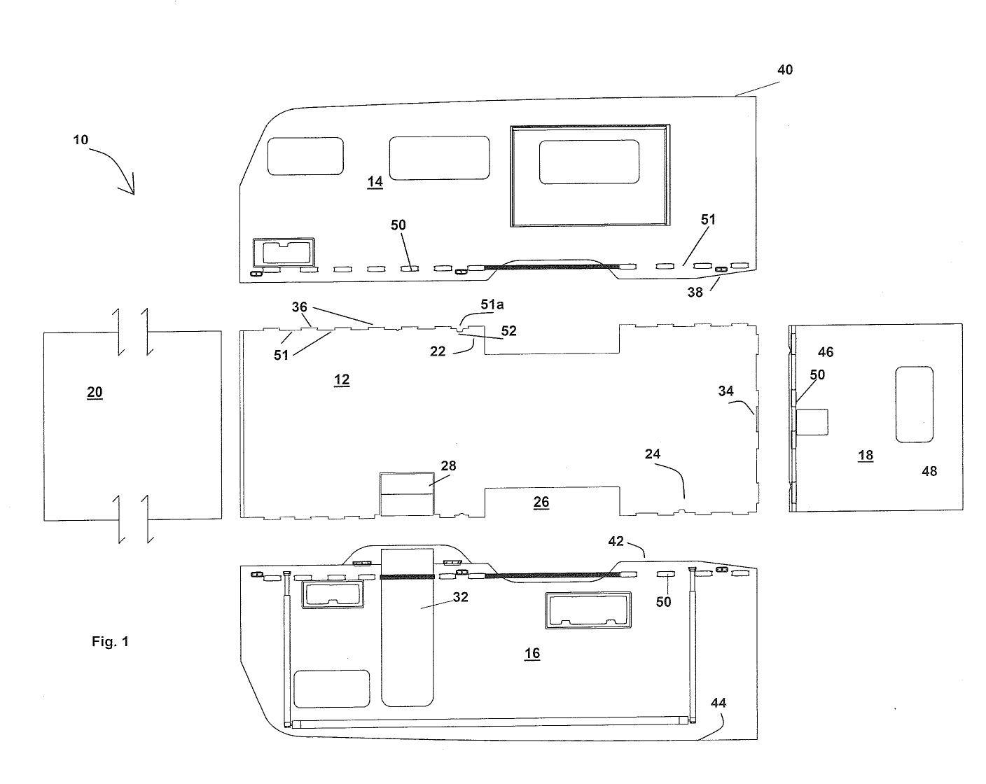

FIG. 1 shows a kit 10 of parts for a preferred caravan body of the present invention. The kit 10 has a floor 12, a driver's side wall 14, a passenger side wall 16, a rear end wall 18 and a roof 20. (The front end wall is not shown).

Each of the floor 12, side walls 14, 16 and roof 20 are formed from a single insulated sandwich panel having fibreglass outer skins and an inner insulation layer of PET.

The floor 12 has opposed side edges being a driver's side edge 22 and a passenger side edge 24. Each side edge 22, 24 has a cut out 26 for receiving a wheel arch. The passenger side edge 24 has an additional cut out 28 for receiving steps that lead up to a doorway 32 in the passenger side wall 16. The floor 12 also has a rear edge 34.

Each side edge 22, 24 and rear edge 34 of the floor 12 has a series of spaced projections 36. Between the projections 36 are recesses 51. The width of the recesses 51 is about the same width as the projections 36.

The driver's side wall 14, passenger side wall 16 and rear wall 18 each have a lower edge and an upper edge, respectively 38, 40; 42, 44; and 46, 48. Each lower edge, 38, 42, 46 has a series of spaced apertures 50, separated by land portions 49. The apertures 50 are dimensioned to be complimentary to and be able to snugly receive projections 36 on the floor.

The land portions 49 between the apertures 50 are also complimentary to the recesses 51 in the floor edge profile.

Some of the recesses 51a have a vertical slot 52 in the rear thereof. The slot 52 may allow the passage of electrical wires or other suitable service connections to pass up or down through the floor.

During construction of the body 10, the walls 14, 16 are vertically aligned with the floor and pushed towards the floor side edges so that the projections 36 are snuggly received within apertures 50. The side walls 14, 16 are secured in place on the floor using a suitable adhesive and/or screws. It may be appreciated that the physical engagement between the floor and walls provides a positive engagement. Further these is intimate contact between the floor and the wall along the full length of the floor and wall.

The rear wall 18 is similarly joined to the rear edge 34 of the floor 12.

It may be appreciated that the walls are securely held in place along their full length with respect to the floor. There is intimate and positive contact between the floors and the walls along the full length thereof. This has led to a number of surprising and advantages.

First, it will be appreciated that the vibrational forces that are experienced during road travel can cause loosening of screws and other conventional methods of attachment. The vibrational stresses are borne by the connectors. However, in the arrangement as shown in the figures, vibrational forces are transmitted between the floor and the side walls and absorbed thereby. Such shock absorption may be found in fibreglass monocoque construction. However, the disclosed panels and construction method is significantly less labour intensive, and more cost effective than monocoque construction.

Further, the projections and apertures provide for extremely accurate alignment during construction. This can also reduce construction time and thus lead to a decrease in labour costs.

Further, Still further, in the event of an accident or collision, in order for the walls to separate from the floor, each one of the floor projections must be sheared. It will be appreciated that the likelihood of this happening is extremely low.

After the walls have been joined to the floor, the roof is placed on the walls and adhered thereto. An aluminium bracket corner that extends along the full length of the wall is used to further secure the roof to the walls.

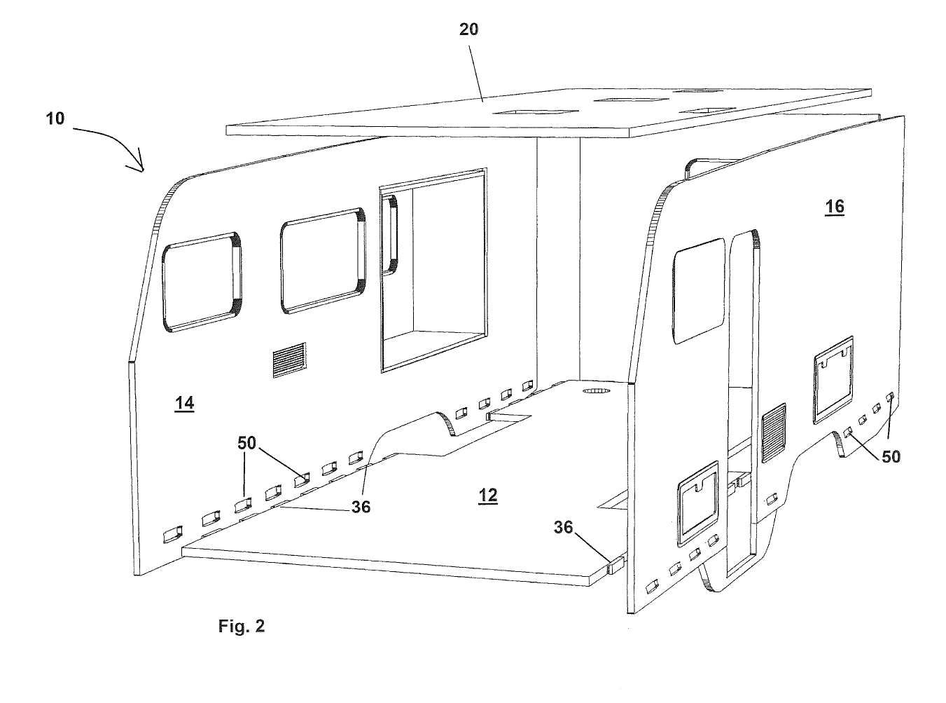

FIG. 2 is a schematic view of the body showing how the projections 36 on the floor 12 align with the apertures 36 in the side walls 14, 16. It may be seen that the apertures 36 are visible from the outer side of the side wall 16. This may be covered by an aluminium cover plate or the like. The cover plate may also serve to protect the lower part of the outer wall from damage.

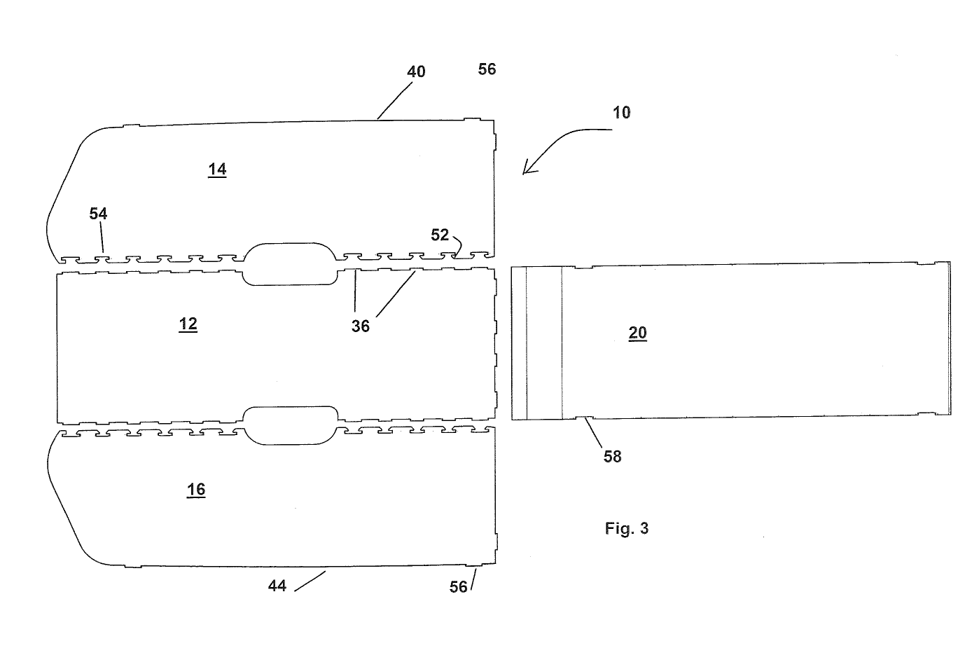

FIG. 3 shows a kit of parts for another embodiment of a vehicle body. The same reference numerals will be used to refer to the same items as shown in FIGS. 1 and 2. In FIG. 3 the side walls 14, 16 have an alternative arrangement for the shape of projection receiving sections 54. In this case, the sections 54 form part of the lower edge profile of the walls 14, 16. The profile has a neck portion 55 below a projection receiving section 54. The neck 55 serves to retain the projections in place within sections 54.

The upper edges 40, 44 of the side walls 14, 16 have vertically extending projections 56 and the rear edges have rearwardly extending projections 60. The roof 20 sits on the upper edges 40. 44 of the side walls 14, 16 as per a conventional butt joint arrangement. The recesses 58 however receive projections 56 which serve to locate the roof 20 on the walls 14, 16 during construction. The rear projections 59 serve a similar purpose to locate the rear wall (not shown).

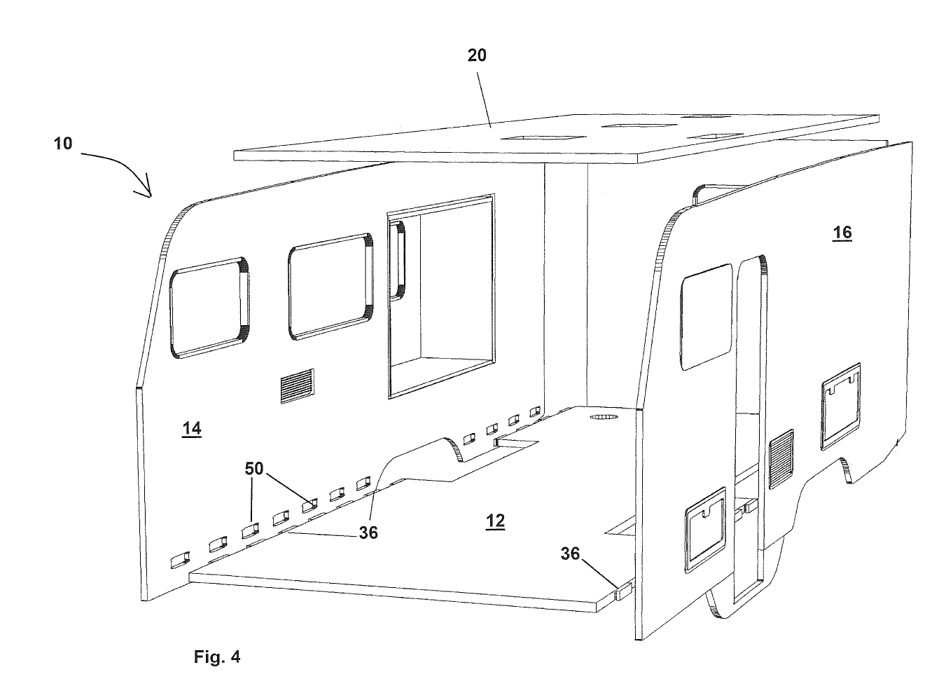

FIG. 4 shows n schematic view of a still further body 9 of the disclosure. In this case, the projection receiving portions 50 are recesses rather than through apertures and do not fully extend through the walls 14, 16. The outside of the walls are flush and there is a clean line to the lower section of the outer side walls.

The manner in which the side walls are fixed to the floor makes the join and thus the body significantly stronger than when simply screwed together according to traditional methods. This means that the body does not rely upon the chassis for structural strength, an advantage previously found only monocoque construction. This allows the chassis to be built with less strength and therefore less weight.

Further, the body does not rely upon mechanical fasteners to hold the panels together. Mechanical fasteners are subject to loosening when subject to vibration and other stresses. On the other hand, in the body constructed as shown in the Figures, there are no fasteners to loosen. Further, because of the intimate contact between the projections and the apertures in the walls, vibrational forces are transferred, distributed away from the point of contact and are absorbed by the panels. This is similar to the transfer of shock, stress and the like through a single monocoque shell but without the disadvantages and expense of monocoque construction.

Further still, because of the intimate contact between the panels, there are no traditional types of joins that allow for ingress of moisture, dust or other contaminants.

In other words, the present inventor has developed a solution to the problems of monocoque construction without significantly compromising the advantages thereof.

A further advantage of this method of construction is that the walls can be joined to the floor in square alignment with the floor. This can lead to a considerable decrease in construction time together with higher levels of accuracy.

The panels may be manufactured remote from the assembly sited and transported thereto.

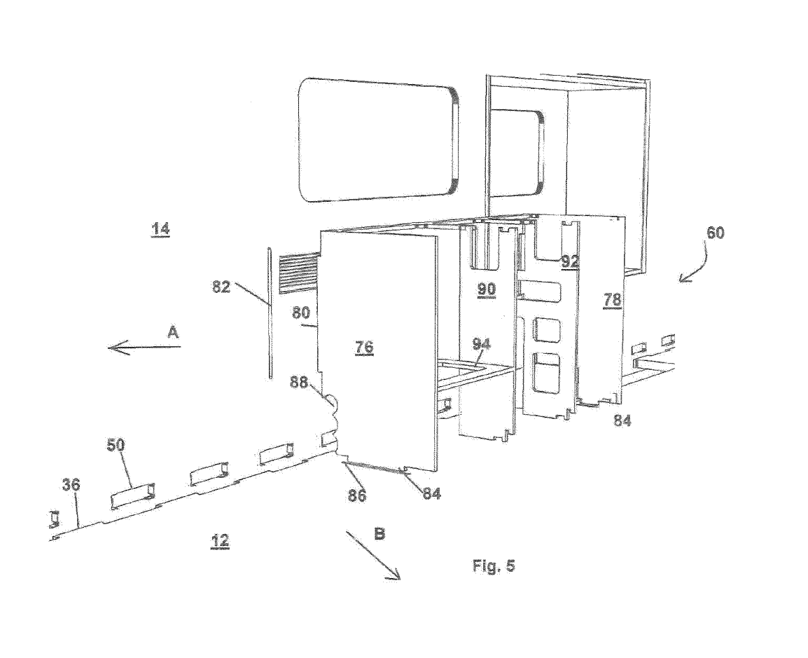

FIG. 5 shows a wall and fixture in the form of a base cabinet assembly 60 ready for installation into the vehicle body 10 as shown in FIG. 1. The base cabinet 60 is a base for a kitchen cabinet.

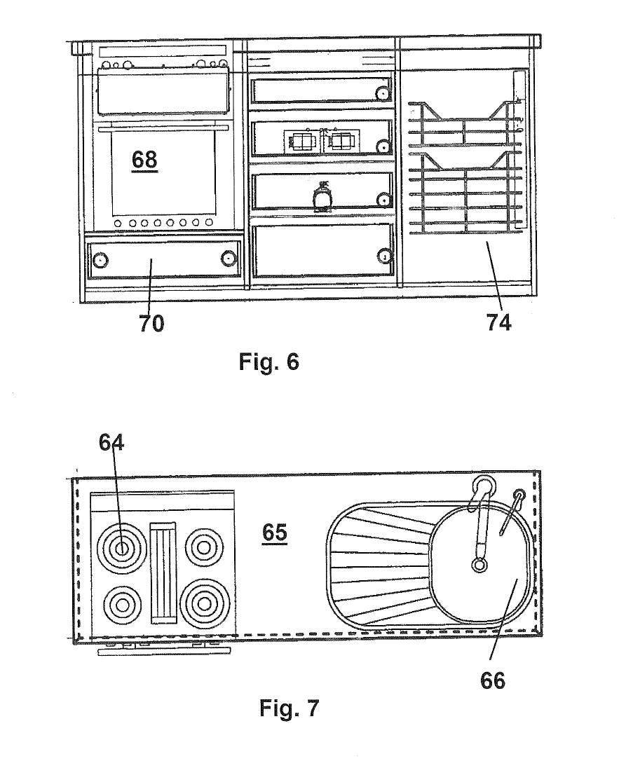

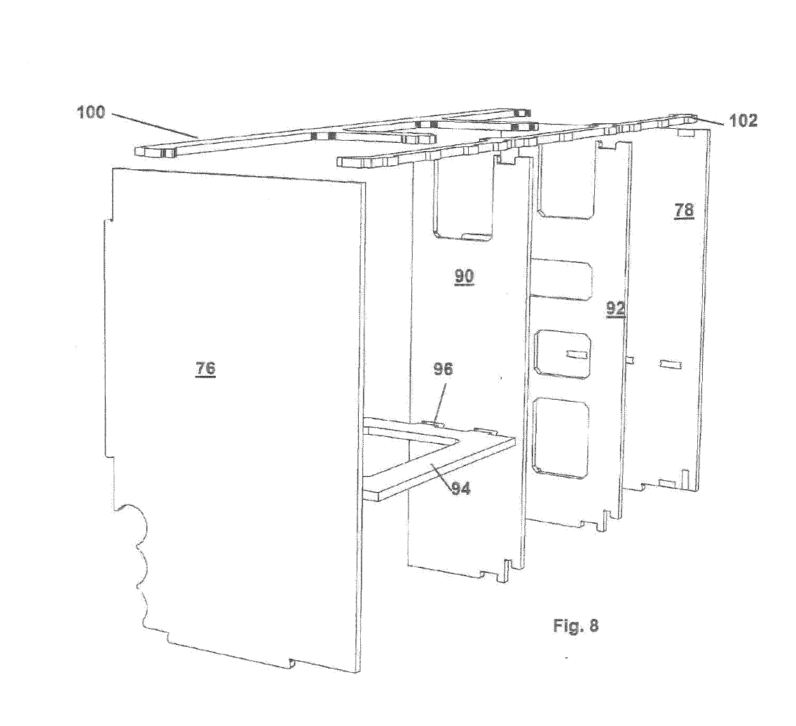

The front and plan views of the finished installed and completed bench 60 are shown in FIGS. 6 and 7. The kitchen cabinet has a top bench 62 into which is installed a cook top 64 and a kitchen sink 66 according to conventional kitchen installation. A bench work area 65 is located between the cook top 64 and sink 66. An oven 68 is mounted below the cook top and below the oven is a drawer 70. 4 drawers 72 are mounted below the work bench 65. A storage area 74 is located beneath the sink 66 that includes two wire baskets that are slidably mounted on rails. The storage area is closed by a door that is mounted on the base cabinet 60 (not shown).

Returning to FIG. 5, the base cabinet assembly 60 has two outer walls 76, 78 and two inner partition walls 90, 92. The outer walls 76, 78 each have a projection 80 extending from the rear edge of the walls 76, 78. The rear edge of wall 78 cannot be seen, but it has the same rear edge profile as wall 76.

The interior of the caravan side wall 14 has a pair of vertical recesses or slots 82. The projections 80 and slots 82 are dimensioned such that the projections 80 can be comfortably and snugly received within slots 82. This secures the wall members against vibration relative the wall and provide for a transfer of energy and shock absorption between the wall members and the caravan walls.

Further, it will be appreciated that any slidable movement of the base cabinet 60 in the direction of forward travel shown by arrow A is resisted by the engagement of the projections 80 in the slots 82. In the case of a collision where significant forces are generated (in the order of 10 to 20G) in order for the base cabinet to break free, the projections would have to shear from the main body portion of the sidewall that it forms part thereof.

The lower edges of each outer wall 76 78 also have a projection 84 extending downwardly therefrom. These projections are received within complimentary recesses or slots 86 located in the body floor 12. In this way, the walls 76, 78 of the cabinet base are further secured in place against sliding in the direction of forward travel indicated by arrow AA . They are also secured against side ways movement in the direction of arrow B. Sideways forces may occur in a collision, jackknifing or if the caravan overturns.

The projections 80 and 86 are glued into place within the respective slots 80, 86. It will be appreciated that the surface area of end walls 76, 78 available for adhesive contact is more than conventionally gluing the edges to the face of the wall or floor as per conventional method of installation.

The lower part of the rear edges of walls 76, 78 have a scalloped section 88. This section 88 provides for service duct access through which services such as electricity, gas and water may pass or flow.

FIG. 8 shows the base cabinet 60 in an exploded view. It may be seen that the 90, 94 walls do not extend fully back so as to abut the wall 14 of the body. It is not necessary to the operation of the cabinet that they do so and reducing the size of the walls where possible can reduce the overall weight of the finished cabinet. Further the walls 90, 92 have apertures 93, which may further reduce the weight.

Outer wall 76 and inner wall 90 define the space that receives the oven 68. A shelf 94 upon which the oven is mounted 94 is supported between the walls 76, 90. The side walls of shelf 94 have two outwardly extending tabs 96 that are received within complimentary recesses 98 in the walls, thereby securing the shelf in place.

The space defined between the inner walls 90, 92 contains the four drawers 72 that are mounted on rails as per known means.

The space between walls 92 and 78 support the sliding wire baskets. A door (not shown) is hingedly attached to end wall 78.

The fixture includes two upper support rails 100, 102. The rails hold the walls in position with respect to each other and support the bench top 65. The support rails and upper edges of the walls are configured for interlocking engagement. The support rails add still further to the strength of the overall structure.

A 26 ft (8 m) motorhome constructed in accordance with the above was determined to have a GVM of 4.5 tonne. This is the maximum laden mass of the vehicle. The GVM takes into consideration the maximum capacity of the fresh water tank (125 L0, grey water tank (100 L), black water tank (38 L), LPG Gas bottles, Diesel fuel tank (75 L), luggage, personal effects and occupants.

A motorhome having of the same length and manufactured according to conventional techniques with conventional cabinetry and fittings has a GVM in the order of 5.5.tonne.

### Pull Tests

Pull tests are used to simulate a crash, with the pull simulating the forward force that would be experienced in a crash. The fixture to be tested is subjected to a pulling force applied at a certain rate of pull and force. The pull force may be applied to a pre set limit or to failure.

In a motorhome, appliances such as televisions, microwaves, washing machines and the like may become deadly projectiles in the event of a crash.

It is estimated that the G force experienced in a crash is up to 20G. A typical television weighs about 5 kg which equates to a force of 100 kg at 20G. A 5 kg television was bolted to the top of interlocking cabinet work as described above in accordance with an aspect of the invention. The television was subjected to a pull tests and remained attached with a pull force of over 120 kg was applied.

By comparison, a pull test on a television fixed to a motorhome cabinet constructed according to conventional motorhome cabinetry construction required a pull test force of only 35 to 40 kg to detach the television.

A similar test was conducted with a microwave with a weight of 12.5 kg. The television was subjected to a pull test and remained attached when a pull force of over 285 kg was applied.

By comparison, a pull test on a 12.5 kg microwave fixed to a motorhome cabinet constructed according to conventional motorhome cabinetry construction required a pull test force of less than 120 kg to detach the microwave.

When larger convection microwave ovens are installed in the cabinetry as disclosed herein, an alloy plate is provided under the microwave which stops the retaining bolts pulling through the board & increases the retention strength to 345 kg.

(This is just under 300% stronger than traditional construction methods).

Motorhome refrigerators range from 41 kg for a 120 Lit unit up to 73 kg for a 220 L refrigerator. The requisite 20G pull force is therefore 1560 kg. Traditional cabinetry construction methods limits the retaining force to under 800 kg

A pull test on a 73 kg refrigerator fixed to cabinetry described showed that the refrigerator remained attached when a pull force of over 1700 kg is applied.

A similar test on a 15 kg washing machine showed that the washing machine remained attached when a pull test of 400 kg is applied.

It may be appreciated that the fixture assembly having one or more projections allows the fixture to positively engage the wall and floor of the body. This provides for a much stronger engagement than with conventional adhesives and mechanical fasteners such as screws, bolts, brackets and the like. It also provides for very accurate alignment of the fixture with respect to the wall. It will be appreciated that in small spaces such as caravans there is very little tolerance for a fixture to be incorrectly located along a caravan wall. This ease of location also makes assembly easier, thereby reducing labour and construction costs.

Still further, when the disclosed fixtures are installed in a body as disclosed herein the fixtures add further to the strength of the vehicle. It is believed that the intimate contact between the projections of the fixtures and the walls allows for dissipation of forces experienced during normal traveling, travelling over rough terrain and in the event of a collision or other extreme force.

It will be appreciated that various changes and modifications may be made to the inventions as disclosed and claimed herein without departing for the spirit and scope thereof.

1. A mobile or transportable body that can be moved or transported by motive power, the body having a floor, front and rear ends, opposing side walls and a roof;
wherein the floor and each side wall are each formed from at least one panel;
the floor has opposing side edges, each side edge having an edge profile defining a plurality of laterally extending projections;
each side wall has an upper edge and a lower edge and each side wall lower edge has a plurality of spaced projection receiving sections located towards the lower edge, the floor side edge projections are received within the projection receiving sections of the side walls so as to engage the side walls wall with the floor and which further includes
a fixture installed adjacent an inner surface of the or each side wall, wherein the fixture has at least one wall member having a rear edge and a forward edge, and at least one projection extending from the rear edge, the inner surface of the adjacent side wall has a recess complimentary to the projection and the projection is received and secured within the recess.

2. The body of claim 1 that further includes a rear end wall, the floor has rear edge with a profile having a plurality of spaced projections and the rear wall has a lower edge with spaced projection receiving sections that are in engagement with the projections on the rear edge of the floor.

3. The body of claim 1, wherein the at least one panel that is of the sandwich type in which an insulating material is housed within opposed skins.

4. The body of claim 1, wherein, each of the side walls and floor are each formed from a single panel.

5. The body of claim 1, wherein the body further includes a roof formed from at least one panel.

6. The body of claim 5, wherein the roof lies on top of upper edges of the side walls, the side walls have vertically extending projections, and the side edges of the roof have recesses that receive the vertically extending locating projections.

7. The body of claim 1, wherein the projection receiving sections are apertures that extend fully through the respective side wall.

8. The body of claim 7, the projections are dimensioned such that the length substantially corresponds to the width of the wall such that the ends of the projections are flush with the outside of the wall and the interior of the wall abuts the recessed edges of the floor between the projections.

9. The body of claim 1, wherein the projection receiving sections are recesses that do not extend fully through the side walls.

10. The body of claim 1, wherein the projection receiving sections form part of the lower edge profile of the wall.

11. The body of claim 1, wherein the body is mounted on a chassis that includes a draw bar for towing.

12. The body of claim 11, wherein the body is a body of a caravan.

13. The body of claim 1, wherein the body is the body of a self-powered motorhome.

14. The body of claim 13 having a length of between about 24 ft and about 28 ft (about 7.3 m to about 8.5 m) and a GVM of 4.5 tonne or less.

15. The body of claim 1, which includes a fixture installed adjacent an inner surface of one or each side wall, wherein the fixture has at least one wall member having a rear edge and a forward edge, and at least one projection extending from the rear edge, the inner surface of the side wall has a recess complimentary to the projection and the projection is received and secured within the recess.

16. A mobile or transportable body that can be moved or transported by motive power, the body having a floor, front and rear ends, opposing side walls and a roof; wherein the floor and each side wall are each formed from at least one panel; the floor has opposing side edges, each side edge having an edge profile defining a plurality of laterally extending projections; each side wall has an upper edge and a lower edge and each side wall lower edge has a plurality of spaced projection receiving sections located towards the lower edge, the floor side edge projections are received within the projection receiving sections of the side walls so as to engage the side walls wall with the floor.

17. A kit for assembling a mobile or transportable body that can be moved or transported by motive power, the body having a floor, front and rear ends opposing side walls and a roof; wherein the kit comprises at least one floor panel, at least one side wall panel and at least one other side wall panel; wherein the or each floor panel has opposing side edges, each side edge having a profile with a plurality of laterally extending spaced projections;
each side wall panel has an upper edge and a lower edge and a series of spaced projection receiving sections located towards the lower edge, wherein the spaced projections receiving sections are configured to receive the projections such that the side walls are engageable with the floor.

18. A method of assembly of a mobile or transportable body that can be moved or transported by motive power the body having a frame, opposing side walls and a roof, the method comprising providing at least one floor panel, at least one side wall panel and at least one other side wall panel; wherein the or each floor panel has opposing side edges, each side edge having a profile with a series of spaced projections;
each side wall panel has an upper edge and a lower edge and a series of spaced projection receiving sections located towards the lower edge, wherein the projections on the floor edges are complimentary to the projection receiving sections;
mounting the at least one floor panel to the frames and mounting said wall panels to said side edges of the floor panel(s) by inserting the projections into the projection receiving sections.

19. A transportable body, the body comprising a floor and opposed side walls and at least one fixture adjacent to one interior side wall, wherein the fixture has at least one wall member having a rear edge and a forward edge, and at least one projection extending from the rear edge, the said internal wall has a recess complimentary to the projection and the projection is received and secured within the recess in the adjacent interior side wall.

20. The body of claim 19, wherein the lower edge of the wall member has a downwardly extending projection that is received by a corresponding recess in the floor.

21. The body of claim 19, wherein the upper edge of the wall member includes a projection projecting upwards from the upper edge of the wall member that is received by a corresponding recess in the roof.

22. A kit for use in the construction of a transportable body having a fixture with at least one wall member installed adjacent at least one internal wall, the kit including at least one body wall having an inner and an outer wall surface, at least one fixture wall member having a rear edge and a front edge and a projection extending from the rear edge, the inner wall has a recess complimentary with the projection such that the projection is received within the recess so as to engage the wall member with the wall.

23. A method of installing a fixture in a mobile or transportable body having an inner wall, the method including providing a fixture with at least one wall member having a rear edge and a front edge and a projection extending from the rear edge, providing the inner wall with a recess complimentary with the projection and placing the projection in the recess.
